(19) United States
(12) Patent Application Publication
(10) Pub. No.: US 2022/0121270 A1
(43) Pub. Date: Apr. 21, 2022

(54) EXHIBITION HALL CONTROL METHOD AND SYSTEM, CONTROL TERMINAL, BACK-END SERVER AND CENTRAL CONTROL HOST

(71) Applicant: BOE TECHNOLOGY GROUP CO., LTD., Beijing (CN)

(72) Inventor: Yao WANG, Beijing (CN)

(21) Appl. No.: 17/417,530

(22) PCT Filed: Nov. 24, 2020
(86) PCT No.: PCT/CN2020/131146

§ 371 Date: Jun. 23, 2021

(30) Foreign Application Priority Data
Nov. 25, 2019 (CN) 201911168740.5

(51) Int. Cl. G06F 3/01; G06F 3/0482; G06T 19/00

(52) U.S. Cl. CPC G06F 3/011; G06F 2203/012; G06T 19/006; G06F 3/0482

(57) ABSTRACT

The application provides an exhibition hall control method, applied to a control terminal, including: displaying a virtual exhibition hall model; generating a device control instruction in response to a first controllable virtual device in the virtual exhibition hall model being operated, the device control instruction including device information of a first controllable physical device that matches the first controllable virtual device, and operation information; and sending the device control instruction to a central control host through a back-end server, so that the central control host controls the first controllable physical device in an exhibition hall to perform a corresponding operation according to the device control instruction. The application also provides a control terminal, a back-end server, a central control host, an exhibition hall control system and a computer readable storage medium.

### CROSS-REFERENCE TO RELATED APPLICATION

This application claims priority to Chinese patent application No. 201911168740.5, filed on Nov. 25, 2019, the entire contents of which are incorporated herein by reference.

### TECHNICAL FIELD

The present disclosure relates to the field of intelligent exhibition halls, and in particular, to an exhibition hall control method and system, a control terminal, a back-end server, a central control host, and a computer-readable storage medium.

### BACKGROUND

In most exhibition halls, the opening, closing and content control of exhibition devices are independent of one another. For example, in the process of opening an exhibition hall, a management staff is required to move to different positions to manually turn on various devices (e.g., a display device, a lighting device, an audio device, and the like.) one by one.

### SUMMARY

The present disclosure provides an exhibition hall control method and system, a control terminal, a back-end server, a central control host, and a computer-readable storage medium.

As a first aspect, an embodiment of the present disclosure provides a method for controlling an exhibition hall, applied to a control terminal, including: displaying a virtual exhibition hall model; generating a device control instruction in response to a first controllable virtual device in the virtual exhibition hall model being operated, the device control instruction including device information of a first controllable physical device that matches the first controllable virtual device, and operation information; and sending the device control instruction to a central control host through a back-end server, so that the central control host controls the first controllable physical device in the exhibition hall to perform a corresponding operation according to the device control instruction.

In some embodiments, the method further includes: in response to a device state of a second controllable physical device in the exhibition hall being changed, receiving a model update instruction sent by the back-end server, the model update instruction including device information and a current device state of a second controllable virtual device that matches the second controllable physical device; and in response to the model update instruction, updating a device state of the second controllable virtual device in the virtual exhibition hall model to the current device state.

In some embodiments, the method further includes: after the back-end server completes processing of collected data uploaded by a data collector, receiving a processing result sent by the back-end server; and displaying the processing result.

In some embodiments, before the step of displaying the virtual exhibition hall model, the method further includes: obtaining relevant data of the virtual exhibition hall model from a database of the back-end server.

As a second aspect, an embodiment of the present disclosure further provides a method for controlling an exhibition hall, applied to a back-end server, including: in response to a first controllable virtual device in a virtual exhibition hall model displayed by a control terminal being operated, receiving a device control instruction sent by the control terminal, the device control instruction including device information of a first controllable physical device that matches the first controllable virtual device, and operation information; and sending the device control instruction to a central control host, so that the central control host controls the first controllable physical device in the exhibition hall to perform a corresponding operation.

In some embodiments, the method further includes: in response to a device state of a second controllable physical device in the exhibition hall being changed, receiving a data update instruction sent by the central control host, the data update instruction including device information and a current device state of the second controllable physical device; in response to the data update instruction, updating relevant data of the virtual exhibition hall model stored in a database; and sending a model update instruction to the control terminal, the model update instruction including device information and a current device state of a second controllable virtual device that matches the second controllable physical device.

In some embodiments, the method further includes: receiving collected data uploaded by a data collector disposed in the exhibition hall; and processing the collected data to obtain a processing result.

In some embodiments, the data collector includes an image collector, and the collected data includes image data; and the step of processing the collected data including: determining at least one of a real-time number of people in each area in the exhibition hall, an attribute of each person, and a movement trajectory of each person according to the image data.

In some embodiments, after the step of processing the collected data, the method further includes: sending the processing result to the control terminal for the control terminal to display the processing result.

In some embodiments, the method further includes: receiving a sensing result uploaded by a human sensor disposed in the exhibition hall; in response to the sensing result being changed from absence of person to presence of person, sending a first operating state switching instruction to the central control host, so that the central control host controls a third controllable physical device corresponding to the human sensor to switch from a standby state to an operating state according to the first operating state switching instruction; and in response to the sensing result being changed from presence of person to absence of person, sending a second operating state switching instruction to the central control host, so that the central control host controls the third controllable physical device corresponding to the human sensor to switch from the standby state to the operating state according to the second operating state switching instruction.

As a third aspect, an embodiment of the present disclosure further provides a method for controlling an exhibition hall, applied to a central control host, including: in response to a first controllable virtual device in a virtual exhibition hall model displayed by a control terminal being operated, receiving through a back-end server a device control instruction sent by the control terminal, the device control instruction including device information of a first controllable physical device that matches the first controllable virtual device and operation information; and in response to the device control instruction, controlling the first controllable physical device in an exhibition hall to perform a corresponding operation.

In some embodiments, the method further includes: in response to monitoring that a device state of a second controllable physical device in the exhibition hall is changed, sending a data update instruction to the back-end server, so that the back-end server updates relevant data of the virtual exhibition hall model stored in a database and sending a model update instruction to the control terminal, the data update instruction including device information and a current device state of the second controllable physical device.

In some embodiments, the method further includes: in response to a sensing result uploaded to the back-end server by a human sensor disposed in the exhibition hall being changed from absence of person to presence of person, receiving a first operating state switching instruction sent by the back-end server; and controlling a third controllable physical device corresponding to the human sensor to switch from a standby state to an operating state according to the first operating state switching instruction.

In some embodiments, the method further includes: in response to a sensing result uploaded to the back-end server by a human sensor disposed in the exhibition hall being changed from presence of person to absence of person, receiving a second operating state switching instruction sent by the back-end server; and controlling a third controllable physical device corresponding to the human sensor to switch from an operating state to a standby state according to the second operating state switching instruction.

As a fourth aspect, an embodiment of the present disclosure further provides a control terminal, including a first processor and a first memory having a first program stored therein, which, when executed by the first processor, implements the steps of the exhibition hall control method provided in the embodiments of the first aspect.

As a fifth aspect, an embodiment of the present disclosure further provides a back-end server, including a second processor and a second memory having a second program stored therein, which, when executed by the second processor, implements the steps of the exhibition hall control method provided in the embodiments of the second aspect.

As a sixth aspect, an embodiment of the present disclosure further provides a central control host, including a third processor and a third memory having a third program stored therein, which, when executed by the third processor, implements the steps of the exhibition hall control method provided in the embodiments of the third aspect.

As a seventh aspect, an embodiment of the present disclosure further provides an exhibition hall control system, including the control terminal provided in the embodiment of the fourth aspect, the back-end server provided in the embodiment of the fifth aspect, and the central control host provided in the embodiment of the seventh aspect.

As a seventh aspect, an embodiment of the present disclosure further provides a computer-readable storage medium having instructions stored therein, which, when executed by a processor, implement the steps of the method provided in the embodiments of the first to third aspects.

### BRIEF DESCRIPTION OF THE DRAWINGS

FIG. 1 is a structural diagram of an exhibition hall control system according to an embodiment of the present disclosure;

FIG. 2 is a flowchart of a method for controlling an exhibition hall according to an embodiment of the present disclosure;

FIG. 3 is a schematic view of an interface for displaying a virtual exhibition hall model by a control terminal according to an embodiment of the present disclosure;

FIG. 4 is a flowchart of another method for controlling an exhibition hall according to an embodiment of the present disclosure;

FIG. 5 is a flowchart of still another method for controlling an exhibition hall according to an embodiment of the present disclosure; FIG. 6 is a schematic diagram of an interface of a control terminal displaying a people attribute screen, a people distribution point map, a people number change map and a people distribution heat map according to an embodiment of the present disclosure;

FIG. 7 is a schematic diagram of a movement trajectory of people shown by a terminal according to an embodiment of the present disclosure;

FIG. 8 is a flowchart of yet another method for controlling an exhibition hall according to an embodiment of the present disclosure;

FIG. 9 is a flowchart of yet another method for controlling an exhibition hall according to an embodiment of the present disclosure;

FIG. 10 is a flowchart of yet another method for controlling an exhibition hall according to an embodiment of the present disclosure;

FIG. 11 is a flowchart of yet another method for controlling an exhibition hall according to an embodiment of the present disclosure;

FIG. 12 is a flowchart of yet another method for controlling an exhibition hall according to an embodiment of the present disclosure;

FIG. 13 is a flowchart of yet another method for controlling an exhibition hall according to an embodiment of the present disclosure;

FIG. 14 is a flowchart of yet another method for controlling an exhibition hall according to an embodiment of the present disclosure;

FIG. 15 is a signaling diagram for controlling, by a control terminal, a controllable physical device in a real exhibition hall to perform a corresponding operation according to the present disclosure;

FIG. 16 is a signaling diagram of state synchronization and data synchronization performed by an exhibition hall control system after a device state of a controllable physical device is changed, according to the present disclosure;

FIG. 17 is a signaling diagram illustrating that a back-end server completes processing of collected data uploaded by a data collector and then sends a processing result to a control terminal for display, according to the present disclosure; and

FIG. 18 is a signaling diagram illustrating that a back-end server controls a corresponding controllable physical device to switch between a standby state and an operating state according to a sensing result uploaded by a human sensor, according to the present disclosure.

### DETAILED DESCRIPTION

In order to make those skilled in the art better understand the technical solutions of the present disclosure, an exhibition hall control method and system, a control terminal, a back-end server, and a central control host provided in the present disclosure are described in detail below with reference to the accompanying drawings.

Exemplary embodiments will be described more fully hereinafter with reference to the accompanying drawings, but these exemplary embodiments may be embodied in different forms and should not be construed as limited to the embodiments set forth herein. Rather, these embodiments are provided so that this disclosure will be thorough and complete, and will fully convey the scope of the present disclosure to those skilled in the art.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “includes” and/or “made of . . . ,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various instructions, devices, these instructions, devices should not be limited by these terms, which are used merely to distinguish one object from another.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In most exhibition halls, the opening, closing and content control of the exhibition devices are independent of one another. For example, in the process of opening an exhibition hall, a management staff is required to move to different positions to manually turn on various devices (e.g., a display device, a lighting device, an audio device, and the like) one by one. Such an operation flow is inefficient, error-prone, and not easily adjustable for emergencies.

Accordingly, the present disclosure provides an exhibition hall control method and system, a control terminal, a back-end server, and a central control host that obviate one or more of the problems due to limitations and disadvantages of the related art.

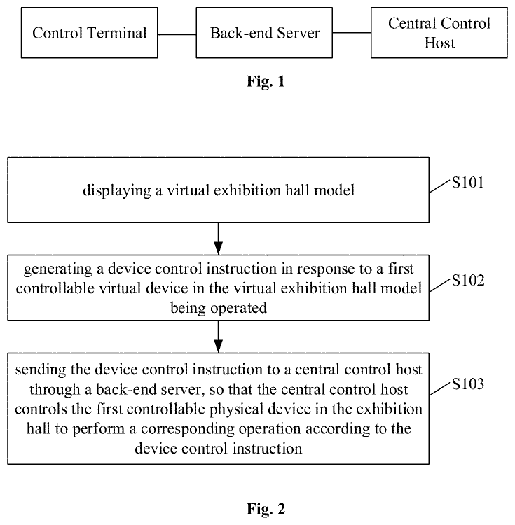

FIG. 1 is a structural diagram of an exhibition hall control system according to an embodiment of the present disclosure, and as shown in FIG. 1, the exhibition hall control system includes: a control terminal, a back-end server and a central control host.

The central control host serves as the core of the control of the whole exhibition hall. Various external actuators (such as a relay, a strong electricity controller, an infrared transmitter and a serial port) are expanded on the central control host to perform the software and hardware control on all controllable physical devices in the exhibition hall, and the central control host stores all control instructions of the controllable physical devices into a standard control instruction library for subsequent calling.

A database of the back-end server stores relevant data of a virtual exhibition hall model. Exemplarily, the virtual reality technology is combined with a three-dimensional modeling tool (for example, a 3DMax modeling tool) in advance to model the real scene of the exhibition hall (also called as digitization), so as to obtain the relevant data of the virtual exhibition hall model for subsequent use by the control terminal. The back-end server may be configured to couple the control terminal and the central control host and serve as a channel and a gateway for transmitting data and control instructions between the virtual exhibition hall and the real exhibition hall.

The control terminal may obtain the relevant data of the virtual exhibition hall model from the database of the back-end server, and render (for example, Unity3D rendering) all controllable physical devices in the real exhibition hall in the form of controllable virtual devices on the 3D model, which is a virtual exhibition hall model and may also be called as a “digital twin exhibition hall”. For each controllable physical device in the real exhibition hall, there will be a matching controllable virtual device in the virtual exhibition hall model. The control terminal includes but is not limited to an operable smart device with a display function, such as a tablet computer, a mobile phone, a personal computer (PC), and the like.

The controllable physical device in the present disclosure refers to a physical device which is located in a real exhibition hall and can be controlled by control instructions to perform operations, such as a power supply controller, an air conditioner, a display, a lighting device, an audio device, a digital sign, a motorized window curtain, and the like.

The management staff can operate the virtual exhibition hall model that is presented by the control terminal to, for example, adjust the size of the virtual exhibition hall model, switch the visual angle of the virtual exhibition hall model at will, watch the controllable virtual device in the virtual exhibition hall model from different angles, watch the panorama view of the virtual exhibition hall model, which is convenient for the management staff to monitor the real exhibition hall in real time. Meanwhile, the management staff can operate the controllable virtual device in the virtual exhibition hall model to control a controllable physical device that matches the controllable virtual device in the real exhibition hall to perform a corresponding operation, which can reduce the difficulty degree of controlling for the management staff, and also is convenient for management staff to carry out centralized management to all controllable physical devices in the real exhibition hall.

The technical solutions of the present disclosure will be described in detail below with reference to exemplary embodiments.

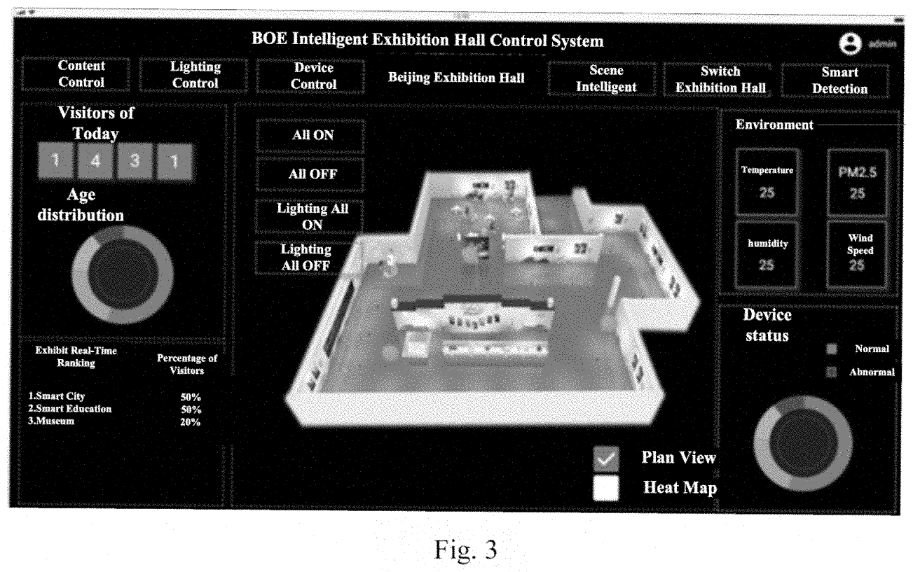

FIG. 2 is a flowchart showing a method for controlling an exhibition hall according to an embodiment of the present disclosure, and as shown in FIG. 2, the exhibition hall control method, which is performed by a control terminal, may include steps S101 to S103.

In step S101, a virtual exhibition hall model is displayed.

In some embodiments, in a process of modeling an exhibition hall, relevant data of the virtual exhibition hall model is stored in a back-end server, and meanwhile, the relevant data of the virtual exhibition hall model is also stored in the control terminal, and the control terminal can directly display the virtual exhibition hall model based on a rendering technology.

In some embodiments, in the process of modeling the exhibition hall, relevant data of the virtual exhibition hall model is only stored in a back-end server, and is not stored in the control terminal. Therefore, before the control terminal displays the virtual exhibition hall model, a step of acquiring the relevant data of the virtual exhibition hall model from the database of the back-end server is required.

FIG. 3 is a schematic diagram of an interface for displaying a virtual exhibition hall model by a control terminal according to an embodiment of the present disclosure, and as shown in FIG. 3, the interface for displaying the virtual exhibition hall model not only includes the virtual exhibition hall model, but also displays other information (for example, virtual function keys (e.g., “content control”, “light control”, “device control”, “all ON in exhibition hall”, “ all OFF in exhibition hall”, “light all ON”, “light all OFF”), information about visitor number, information about exhibition hall environment, device states, real-time ranking of exhibition items, and the like) according to actual needs. It should be noted that FIG. 3 only shows an interface for displaying a virtual exhibition hall model by way of example, which does not limit the technical solution of the present disclosure.

In step S102, a device control instruction is generated in response to a first controllable virtual device in the virtual exhibition hall model being operated.

When a management staff needs to operate one or more controllable physical devices in the real exhibition hall, the management staff only needs to correspondingly operate the matched controllable virtual devices in the virtual exhibition hall model. In this case, the control terminal generates a device control instruction in response to an operation from the management staff. The device control instruction includes: device information (e.g., device identification or device name) of a first controllable physical device that matches the first controllable virtual device, and operation information.

It should be noted that the “first controllable virtual device” in the present disclosure does not refer to a specific controllable virtual device, but refers to one or several controllable virtual devices currently operated by the management staff in the virtual exhibition hall model. In this case, the “first controllable physical device” is a controllable physical device (i.e., a controllable physical device that the management staff currently wants to operate) in the real exhibition hall and matched with the first controllable virtual device.

In step S103, the device control instruction is sent to a central control host through the back-end server, so that the central control host controls the first controllable physical device in the exhibition hall to perform a corresponding operation according to the device control instruction.

The control terminal sends the device control instruction to the back-end server, the back-end server forwards the device control instruction to the central control host, and the central control host may send a standard control instruction corresponding to the operation information to the first controllable physical device in the real exhibition hall through the external actuator (various operation information and corresponding standard control instructions are stored in advance in the control instruction library of the central control host), so as to control the first controllable physical device to perform a corresponding operation.

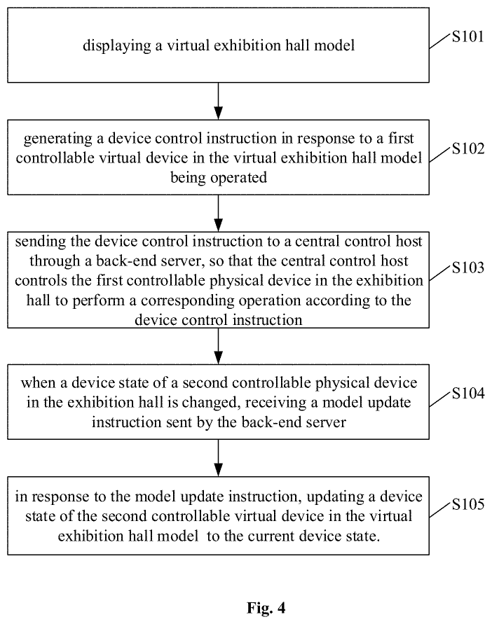

FIG. 4 is a flowchart of another method for controlling an exhibition hall according to an embodiment of the present disclosure, and as shown in FIG. 4, the method, which is performed by a control terminal, includes step S104 and step S105 in addition to the steps S101 to S103.

In step S104, when a device state of a second controllable physical device in the exhibition hall is changed, a model update instruction sent by the back-end server is received.

In the present disclosure, the central control host may also monitor whether the device state of each controllable physical device in the exhibition hall is changed in real time, and when it is monitored that the device state of a controllable physical device is changed (for example, the brightness of a certain lamp becomes high, or the volume of a certain audio device decreases), the central control host may send a data update instruction to the back-end server. The data update instruction includes device information and a current device state of the second controllable physical device.

It should be noted that, in the present disclosure, the “second controllable physical device” refers to one or more controllable physical devices whose device state changes in the real exhibition hall monitored by the central control host.

After receiving the data update instruction, the back-end server updates the relevant data of the virtual exhibition hall model stored in the database and sends the model update instruction to the control terminal. The model update instruction includes device information and a current device state of a second controllable virtual device that matches the second controllable physical device.

In step S105, in response to the model update instruction, a device state of the second controllable virtual device in the virtual exhibition hall model is updated to the current device state.

The control terminal updates the device state of the second controllable virtual device in the virtual exhibition hall model to the current device state according to the received model update instruction, so as to realize the state synchronization of the virtual exhibition hall model and the real exhibition hall, while can realize the data synchronization of the control terminal and the back-end server.

In the present disclosure, the first controllable virtual device is a virtualized representation of the first controllable physical device in the virtual exhibition hall model, and the second controllable virtual device is a virtualized representation of the second controllable physical device in the virtual exhibition hall model. In the present disclosure, the first controllable virtual device (first controllable physical device) may be the same as the second controllable virtual device (second controllable physical device) or may be different from the second controllable virtual device (second controllable physical device).

As a first exemplary scenario, the management staff controls a controllable physical device A in the real exhibition hall to change the device state thereof by operating the controllable virtual device A′ in the virtual exhibition hall model (the controllable virtual device A′ is the virtualized representation of the controllable physical device A). When the controllable physical device A changes its device state in response to a standard control instruction sent by the central control host, the central control host monitors that the device state of the controllable physical device A is changed and sends a data update instruction to the back-end server. The back-end server updates relevant data of the controllable virtual device A′ in the database after receiving the data update instruction and sends a model update instruction to the control terminal. The control terminal updates the device state of the controllable virtual device A′ in the virtual exhibition hall model after receiving the model update instruction. In the first exemplary scenario, each of the first controllable virtual device and the second controllable virtual device is the controllable virtual devices A′, and each of the first controllable physical device and the second controllable physical device is the controllable virtual devices A.

As a second exemplary scenario, the management staff controls the controllable physical device A in the real exhibition hall to change the device state thereof by operating the controllable virtual device A′ in the virtual exhibition hall model. Meanwhile, another management staff directly adjusts another controllable physical device B in the real exhibition hall, so that the device state of the controllable physical device B is changed. Based on the flow of the state synchronization and the data synchronization as described above, the back-end server updates the relevant data of the controllable virtual device B′ in the database, and the control terminal updates the device state of the controllable virtual device B′ in the virtual exhibition hall model. In the second example scenario, the first controllable virtual device is the controllable virtual device A′, the second controllable virtual device is the controllable virtual device B′, the first controllable physical device is the controllable physical device A, and the second controllable physical device is the controllable physical device B.

It should be noted that, in the technical solution of the present disclosure, the execution order of steps S104 to S105 and steps S101 to S103 is not limited, that is, steps S104 to S105 may be executed before steps S101 to S103 (no corresponding example is given), or executed after steps S101 to S103 (for example, in case of the first exemplary scenario), or executed concurrently with steps S101 to S103 (for example, in case of the second exemplary scenario). FIG. 4 only shows, by way of example, the case where steps S104 to S105 are performed after step S103.

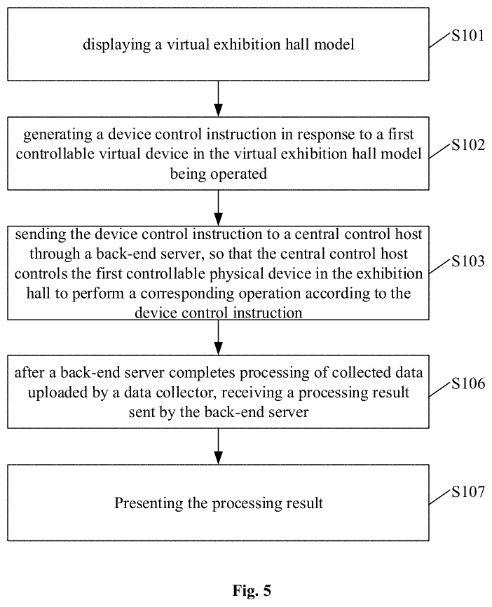

FIG. 5 is a flowchart of still another method for controlling an exhibition hall according to an embodiment of the present disclosure, and as shown in FIG. 5, the method, which is performed by a control terminal, includes step S106 and step S107 in addition to steps S101 to S103.

In step S106, after a back-end server completes processing of collected data uploaded by a data collector, a processing result sent by the back-end server is received.

In an embodiment of the present disclosure, a plurality of data collectors may be arranged in the real exhibition hall, these data collectors may send collected data to the back-end server, and the back-end server may process the collected data accordingly and generate a processing result.

As an example, the data collector includes an image collector (e.g., a camera), and the collected data uploaded by the data collector is image data. The back-end server may perform real-time analysis and processing on the image data uploaded by each image collector in the real exhibition hall through an image processing technology (e.g., a facial recognition technology, a target tracking technology, etc.) to obtain at least one of a real-time number of people in each of areas in the real exhibition hall, attributes (e.g., gender, age, VIP person, blacklist person, etc.) of each person, and a movement trajectory of each person, and output the structured data of processing result. The back-end server may send the obtained processing result to the control terminal.

In step S107, the processing result is displayed.

The display mode of the processing result is not limited in the present disclosure.

FIG. 6 is a schematic diagram of an interface of a control terminal displaying a people attribute screen, a people distribution point map, a people number change map and a people distribution heat map according to an embodiment of the present disclosure. As shown in FIG. 6, as an example, the processing result includes a people attribute recognition result and a real-time number of people in each area. The control terminal may display the processing result in four display areas: a people attribute recognition result is displayed in the upper left display area, a people distribution point map in the exhibition hall is displayed in the upper right display area, a people number change map is displayed in the lower left display area, and a people distribution heat map in the exhibition hall is displayed in the lower right display area.

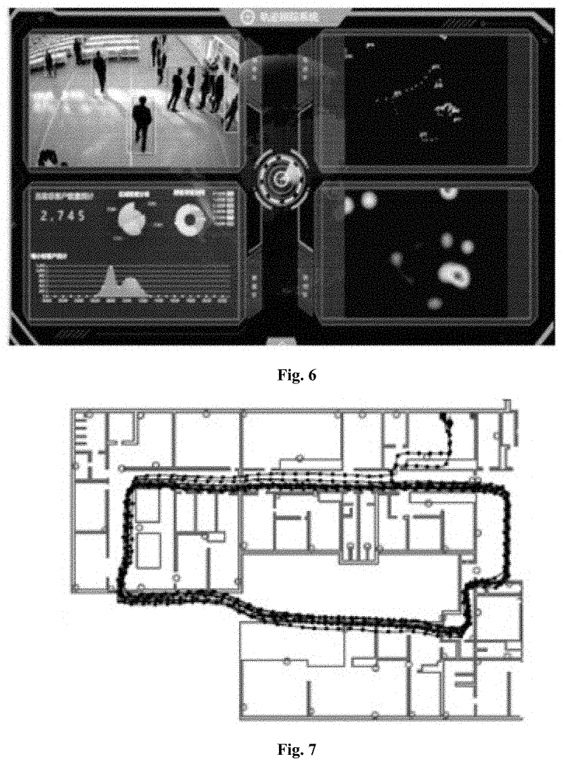

FIG. 7 is a schematic diagram of a movement trajectory of people shown by a terminal according to an embodiment of the present disclosure. As shown in FIG. 7, as an example, the processing result includes a movement trajectory of people, and in this case, the movement trajectory of at least some people is displayed by combining with the virtual exhibition hall model.

In the present disclosure, the management staff can intuitively view the real-time status of the whole exhibition hall, and the management staff can make operation and maintenance decisions quickly by using these data. For example, a management staff is sent to an area with a large number of visitors, and exhibits in an area with a small number of visitors are replaced with other exhibits.

As an example, VIP or blacklist data may be added in the back-end server, and attributes of the people in the exhibition hall may be identified through facial recognition techniques. When a VIP person or a blacklisted person appears in the exhibition hall, the VIP person or the blacklisted person can be captured by the data collector and identified by the back-end server, and the back-end server can quickly push a processing result to the control terminal of the management staff so as to remind the management staff.

It should be noted that, in the technical solution of the present disclosure, the execution order of steps S106 to S107 and steps S101 to S103 is not limited, that is, steps S106 to S107 may be executed before steps S101 to S103, or executed after steps S101 to S103, or executed concurrently with steps S101 to S103. FIG. 5 only shows, by way of example, the case where steps S106 to S107 are performed after step S103.

In the present disclosure, the steps in the embodiments shown in FIG. 2, FIG. 4 and FIG. 5 may be combined with each other to obtain a new embodiment, and the new embodiment should also fall into the protection scope of the present disclosure.

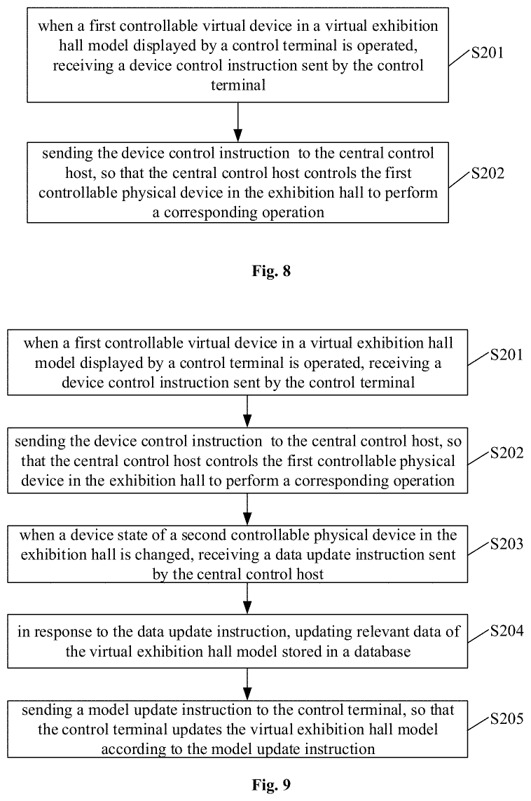

FIG. 8 is a flowchart of yet another method for controlling an exhibition hall according to an embodiment of the present disclosure, and as shown in FIG. 8, the method, which is performed by a back-end server, may include step S201 and step S202.

In step S201, when a first controllable virtual device in a virtual exhibition hall model displayed by a control terminal is operated, a device control instruction sent by the control terminal is received.

The device control instruction includes operation information and device information of a first controllable physical device that matches the first controllable virtual device.

In step S202, the device control instruction is sent to the central control host, so that the central control host controls the first controllable physical device in the exhibition hall to perform a corresponding operation.

For the specific description of step S201 and step S202, reference may be made to corresponding contents in the foregoing embodiments, which are not described herein again.

FIG. 9 is a flowchart of yet another method for controlling an exhibition hall according to an embodiment of the present disclosure, and as shown in FIG. 9, the method, which is performed by a back-end server, includes steps S203 to S205 in addition to steps S201 to S202.

In step S203, when a device state of a second controllable physical device in the exhibition hall is changed, a data update instruction sent by the central control host is received.

The data update instruction includes device information and current device state of the second controllable physical device.

In step S204, in response to the data update instruction, relevant data of the virtual exhibition hall model stored in a database is updated.

In step S205, a model update instruction is sent to the control terminal, so that the control terminal updates the virtual exhibition hall model according to the model update instruction.

The model update instruction includes device information and a current device state of a second controllable virtual device that matches the second controllable physical device.

For the specific description of steps S203 to S205, reference may be made to corresponding contents in the foregoing embodiments, which are not described herein again.

It should be noted that, in the technical solution of the present disclosure, the execution order of steps S203 to S205 and steps S201 to S202 is not limited, that is, steps S203 to S205 may be executed before steps S201 to S202, or executed after steps S201 to S202, or executed concurrently with steps S201 to S202. FIG. 9 only shows, by way of example, the case where steps S203 to S205 are performed after step S202.

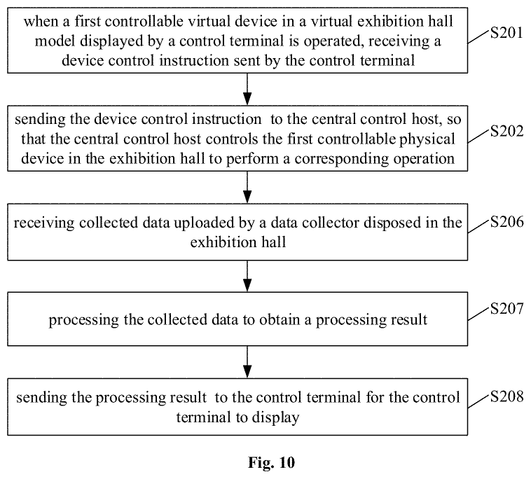

FIG. 10 is a flowchart of yet another method for controlling an exhibition hall accordingly to an embodiment of the present disclosure, and as shown in FIG. 10, the method, which is performed by a back-end server, includes steps S206 to S208 in addition to steps S201 to S202.

In step S206, collected data uploaded by a data collector disposed in the exhibition hall is received.

In step S207, the collected data is processed to obtain a processing result.

In some embodiments, the data collector includes an image collector (e.g., a camera), and the collected data includes image data; and the step of processing the collected data may include: determining at least one of a real-time number of people in each area in the exhibition hall, an attribute of each person and a movement trajectory of each person according to the image data.

In step S208, the processing result is sent to the control terminal, and the control terminal displays the processing result.

For the specific description of steps S206 to S208, reference may be made to corresponding contents in the foregoing embodiments, which are not described herein again.

It should be noted that, in the technical solution of the present disclosure, the execution order of steps S206 to S208 and steps S201 to S202 is not limited, that is, step S206 to step S208 may be executed before step S201 to step S202, or executed after step S201 to step S202, or executed concurrently with step S201 to step S202. FIG. 10 only shows, by way of example, the case where steps S206 to S208 are performed after step S202.

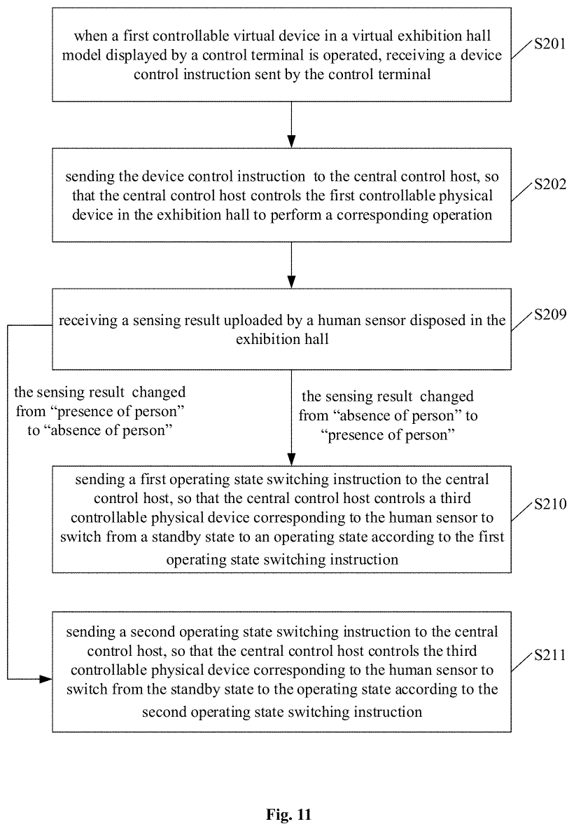

FIG. 11 is a flowchart of yet another method for controlling an exhibition hall according to an embodiment of the present disclosure, and as shown in FIG. 11, the method, which is performed by a back-end server includes steps S209 to S211 in addition to steps S201 to S202.

In step S209, a sensing result uploaded by a human sensor disposed in the exhibition hall is received.

In an embodiment of the present disclosure, corresponding human sensors may be configured for some of the controllable physical devices (for example, digital tags) in the real exhibition hall, and a human sensor may detect whether a human body exists near a controllable physical device corresponding to the human sensor and upload a detection result to the back-end server.

The back-end server receives sensing results uploaded by the human sensors in real time; when a sensing result received by the back-end server from a human sensor is changed from “absence of person” to “presence of person”, step S210 is performed; and when a sensing result received by the back-end server from a human sensor is changed from “presence of person” to “absence of person”, step S211 is performed.

In step S210, a first operating state switching instruction is sent to the central control host.

When a sensing result received by the back-end server from a human sensor is changed from “absence of person” to “presence of person”, it indicates that a person reaches the vicinity of the controllable physical device (namely, the third controllable physical device) corresponding to the human sensor, and the back-end server sends a first operating state switching instruction to the central control host, so that the central control host controls the third controllable physical device corresponding to the human sensor to switch from a standby state to an operating state according to the first operating state switching instruction. The first operating state switching instruction includes device information of the third controllable physical device corresponding to the human sensor and operation information required by the central control host for switching the third controllable physical device to an operating state.

In step S211, a second operating state switching instruction is sent to the central control host.

When a sensing result received by the back-end server from a human sensor is changed from “presence of person” to “absence of person”, it indicates that no person exists in the vicinity of the controllable physical device corresponding to the human sensor, and the back-end server sends a second operating state switching instruction to the central control host, so that the central control host controls a third controllable physical device corresponding to the human sensor to switch from an operating state to a standby state according to the second operating state switching instruction. The second operating state switching instruction includes device information of the third controllable physical device corresponding to the human sensor and operation information required by the central control host for switching the third controllable physical device to a standby state.

As an example, the real exhibition hall is provided with a digital tag therein, and the digital tag may explain an exhibit in form of at least one of characters, images, audio or video. Each digital tag (an example of the controllable physical device) is configured with a corresponding infrared human body induction sensor (an example of the human sensor), and each infrared human body induction sensor may detect whether a human body exists in the vicinity of the corresponding digital tag and upload a detection result to a server. Taking a digital tag C as an example, when no one is near the digital tag C, the digital tag C is in a standby state; and when a person arrives near the digital tag C, the detection result of the infrared human body induction sensor corresponding to the digital tag C is changed from the “absence of person” to the “presence of person”. In response to such a change, the back-end server sends a first operating state switching instruction (including device information of the controllable physical device C and operation information required by the central control host for switching the controllable physical device C to the operating state) to the central control host, and the central control host controls the controllable physical device C to switch from the standby state (i.e., no exhibition explanation) to the operating state (i.e., the exhibit is explained) according to the received first operating state switching instruction. When all the people near the controllable physical device C leave, the detection result of the infrared human body induction sensor corresponding to the digital label C is changed from the “presence of person” to the “absence of person”. In response to such a change, the back-end server sends a second operating state switching instruction (including device information of the controllable physical device C and operation information required by the central control host for switching the controllable physical device C to the standby state) to the central control host, and the central control host controls the controllable physical device C to switch from the operating state (i.e., the exhibit is explained) to the standby state (i.e., no exhibition explanation) according to the received second operating state switching instruction.

In the present disclosure, the steps in the embodiments shown in FIG. 8, FIG. 9, FIG. 10 and FIG. 11 may be combined with each other to obtain a new embodiment, and the new embodiment should also fall into the protection scope of the present disclosure.

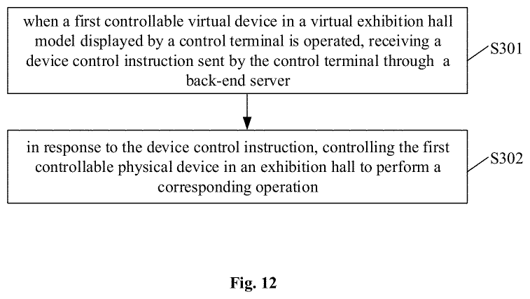

FIG. 12 is a flowchart of yet another method for controlling an exhibition hall according to an embodiment of the present disclosure, and as shown in FIG. 12, the method, which is performed by a central control host, may include step S301 and step S302.

In step S301, when a first controllable virtual device in a virtual exhibition hall model displayed by a control terminal is operated, a device control instruction sent by the control terminal is received through a back-end server.

The device control instruction includes device information of a first controllable physical device that matches the first controllable virtual device and operation information.

In step S302, in response to the device control instruction, the first controllable physical device in an exhibition hall is controlled to perform a corresponding operation.

For the specific description of step S301 and step S302, reference may be made to corresponding contents in the foregoing embodiments, which are not described herein again.

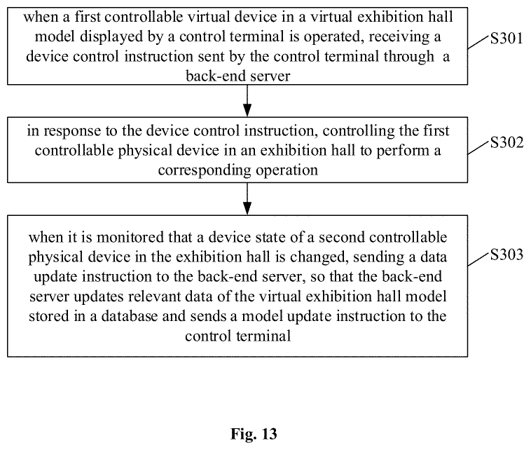

FIG. 13 is a flowchart of yet another method for controlling an exhibition hall according to an embodiment of the present disclosure, and as shown in FIG. 13, the method, which is performed by a central control host, includes step S303 in addition to steps S301 to S302.

In step S303, when it is monitored that a device state of a second controllable physical device in the exhibition hall is changed, a data update instruction is sent to the back-end server, so that the back-end server updates relevant data of the virtual exhibition hall model stored in a database and sends a model update instruction to the control terminal.

The data update instruction includes device information and a current device state of the second controllable physical device.

For the specific description of step S303, reference may be made to corresponding contents in the foregoing embodiments, which are not described herein again.

It should be noted that, in the technical solution of the present disclosure, the execution order of step S303 and steps S301 to S302 is not limited, that is, step S303 may be executed before steps S301 to S302, or executed after steps S301 to S302, or executed concurrently with steps S301 to S302. FIG. 13 only shows, by way of example, the case where step S303 is executed after step S302.

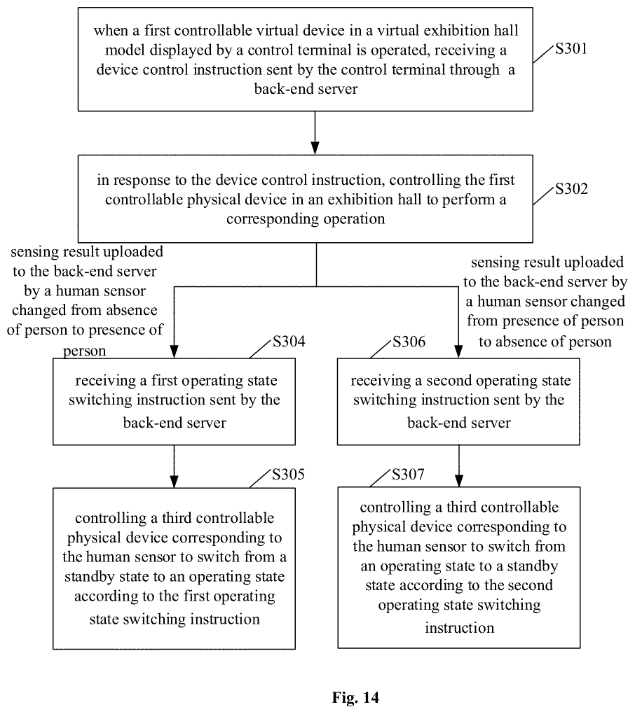

FIG. 14 is a flowchart of yet another method for controlling an exhibition hall according to an embodiment of the present disclosure, and as shown in FIG. 14, the method, which is performed by a central control host, includes steps S304 to S307 in addition to steps S301 to S302.

In step S304, when a sensing result uploaded to the back-end server from a human sensor disposed in the exhibition hall is changed from the “absence of person” to the “presence of person”, a first operating state switching instruction sent by the back-end server is received.

In step S305, a third controllable physical device corresponding to the human sensor is controlled to switch from a standby state to an operating state according to the first operating state switching instruction.

In step S306, when the sensing result uploaded to the back-end server by the human sensor disposed in the exhibition hall is changed from the “presence of person” to the “absence of person”, a second operating state switching instruction sent by the back-end server is received.

In step S307, the third controllable physical device corresponding to the human sensor is controlled to switch from the operating state to the standby state according to the second operating state switching instruction.

For the specific description of steps S304 to S307, reference may be made to corresponding contents in the foregoing embodiments, which are not described herein again.

It should be noted that, in the technical solution of the present disclosure, the execution order of steps S304 to S305, steps S306 to S307, and steps S301 to S302 is not limited. FIG. 14 only shows, by way of example, the case where steps S304 to S305 and steps S306 to S307 are performed after step S302.

In the present disclosure, the steps in the embodiments shown in FIG. 12, FIG. 13 and FIG. 14 may be combined with each other to obtain a new embodiment, and the new embodiment should also fall into the protection scope of the present disclosure.

An embodiment of the present disclosure further provides a control terminal, including a first processor and a first memory having a first program stored therein, which, when executed by the first processor, implements the steps of the exhibition hall control method provided in the embodiments shown in FIG. 2, FIG. 4 and FIG. 5.

An embodiment of the present disclosure further provides a back-end server, including a second processor and a second memory having a second program stored therein, which, when executed by the second processor, implements the steps of the exhibition hall control method provided in the embodiments shown in FIG. 8, FIG. 9, FIG. 10 and FIG. 11.

An embodiment of the present disclosure further provides a central control host, including a third processor and a third memory having a third program stored therein, which, when executed by the third processor, implements the steps of the exhibition hall control method provided in the embodiments shown in FIG. 12, FIG. 13 and FIG. 14.

An embodiment of the present disclosure further provides an exhibition hall control system, including the control terminal, the back-end server and the central control host provided in the foregoing embodiments.

An embodiment of the present disclosure further provides a computer-readable storage medium having instructions stored therein, which, when executed by a processor, implement the steps of any one of the methods described herein.

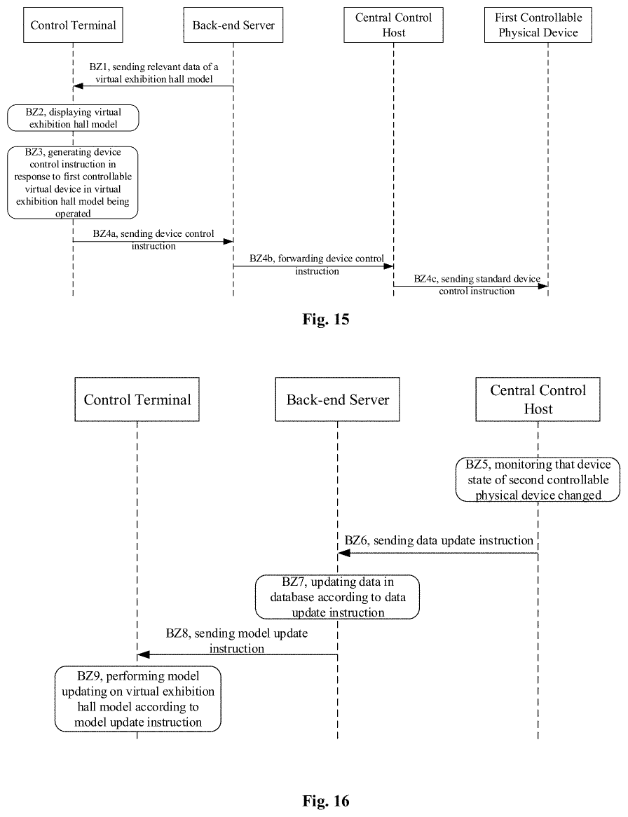

FIG. 15 is a signaling diagram for controlling, by a control terminal, a controllable physical device in a real exhibition hall to perform a corresponding operation, according to the present disclosure. As shown in FIG. 15, signaling interaction between parties may include: BZ1, acquiring, by a control terminal, relevant data of a virtual exhibition hall model from a database of a back-end server; BZ2, displaying the virtual exhibition hall model; BZ3, generating, by a control terminal, a device control instruction in response to a first controllable virtual device in the virtual exhibition hall model being operated; BZ4a, sending the device control instruction to the back-end server; BZ4b, forwarding, by the back-end server, the device control instruction to the central control host; and BZ4c, generating and sending, by the central control host, a standard control instruction according to the device control instruction, so as to control a first controllable physical device in the exhibition hall to perform a corresponding operation. In some embodiments, BZ1 is an optional step.

FIG. 16 is a signaling diagram of state synchronization and data synchronization performed by an exhibition hall control system after a device state of a controllable physical device is changed, according to the present disclosure. As shown in FIG. 16, signaling interaction between parties may include: BZ5, monitoring, by the central control host, that a device state of a second controllable physical device is changed; BZ6, sending, by the central control host, a data update instruction to a back-end server; BZ7, updating, by the back-end server, data in a database according to the data update instruction; BZ8, sending, by the back-end server, a model update instruction to a control terminal; and BZ9, performing, by the control terminal, model updating on a virtual exhibition hall model according to the model update instruction.

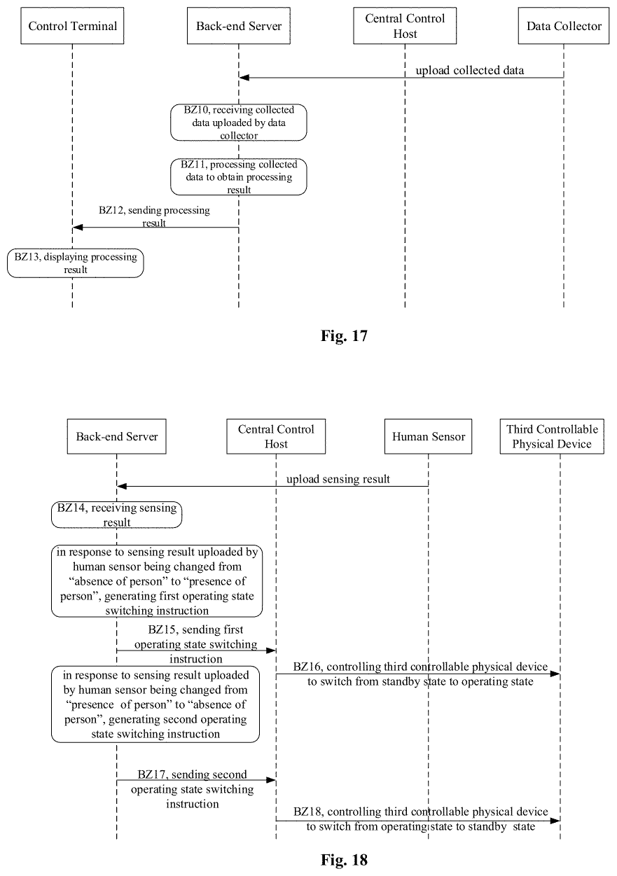

FIG. 17 is a signaling diagram illustrating that a back-end server completes processing of collected data uploaded by a data collector and then sends a processing result to a control terminal for display, according to the present disclosure. As shown in FIG. 17, signaling interaction between parties may include: BZ10, receiving, by a back-end server, collected data uploaded by a data collector; BZ11, processing, by the back-end server, the collected data to obtain a processing result; BZ12, sending the processing result to a control terminal; and BZ13, displaying, by the control terminal, the processing result.

FIG. 18 is a signaling diagram illustrating that a back-end server controls a corresponding controllable physical device to switch between a standby state and an operating state according to a sensing result uploaded by a human sensor, according to the present disclosure. As shown in FIG. 18, signaling interaction between parties may include: BZ14, receiving, by a back-end server, a sensing result uploaded by a human sensor; BZ15, sending a first operating state switching instruction to a central control host in response to the sensing result uploaded by the human sensor being changed from the “absence of person” to the “presence of person”; BZ16, controlling, by a central control host, a third controllable physical device corresponding to the sensor to switch from a standby state to an operating state; BZ17, sending a second operating state switching instruction to the central control host in response to the sensing result uploaded by the human sensor being changed from the “presence of person” to the “absence of person”; BZ18, controlling, by the central control host, the third controllable physical device corresponding to the sensor to switch from the operating state to the standby state.

For the specific description of BZ1 to BZ18, reference may be made to the corresponding contents in the foregoing embodiments, which are not described herein again.

In the present disclosure, the steps in FIGS. 15, 16, 17 and 18 may be combined with each other to obtain a new embodiment, and the new embodiment should also fall into the protection scope of the present disclosure.

It will be understood by those of ordinary skill in the art that all or some of the steps of the methods, functional modules/units in the device, disclosed above may be implemented as software, firmware, hardware, or suitable combinations thereof. In a hardware implementation, the division between functional modules/units mentioned in the above description does not necessarily correspond to the division of physical components; for example, one physical component may have multiple functions, or one function or step may be performed by several physical components in cooperation. Some or all of the physical components may be implemented as software executed by a processor, such as a central processing unit, digital signal processor, or microprocessor, or as hardware, or as an integrated circuit, such as an application specific integrated circuit. Such software may be distributed on computer readable media, which may include computer storage medium (or non-transitory medium) and communication media (or transitory medium). The term computer storage medium includes volatile or nonvolatile, removable or non-removable medium implemented in any method or technology for storage of information such as computer readable instructions, data structures, program modules or other data, as is well known to those skilled in the art. Computer storage medium includes, but is not limited to, RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices, or any other medium which can be used to store the desired information and which can accessed by a computer. In addition, communication medium typically embodies computer readable instructions, data structures, program modules or other data in a modulated data signal such as a carrier wave or other transport mechanism and includes any information delivery medium as is well known to those skilled in the art.

Exemplary embodiments have been disclosed herein, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one skilled in the art. It will, therefore, be understood by those skilled in the art that various changes in form and details may be made therein without departing from the scope of the present disclosure as set forth in the appended claims.

1. A method for controlling an exhibition hall, applied to a control terminal, comprising:
displaying a virtual exhibition hall model;
generating a device control instruction in response to a first controllable virtual device in the virtual exhibition hall model being operated, the device control instruction comprising device information of a first controllable physical device that matches the first controllable virtual device, and operation information; and
sending the device control instruction to a central control host through a back-end server, so that the central control host controls the first controllable physical device in the exhibition hall to perform a corresponding operation according to the device control instruction.

2. The method of claim 1, further comprising:
receiving a model update instruction sent by the back-end server in response to a device state of a second controllable physical device in the exhibition hall being changed, the model update instruction comprising device information and a current device state of a second controllable virtual device that matches the second controllable physical device; and
updating a device state of the second controllable virtual device in the virtual exhibition hall model to the current device state in response to the model update instruction.

3. The method of claim 1, further comprising:
receiving a processing result sent by the back-end server, after the back-end server completes processing of collected data uploaded by a data collector; and
displaying the processing result.

4. The method of claim 1, before the step of displaying the virtual exhibition hall model, further comprising:
obtaining relevant data of the virtual exhibition hall model from a database of the back-end server.

5. A method for controlling an exhibition hall, applied to a back-end server, comprising:
in response to a first controllable virtual device in a virtual exhibition hall model displayed by a control terminal being operated, receiving a device control instruction sent by the control terminal, the device control instruction comprising device information of a first controllable physical device that matches the first controllable virtual device, and operation information; and
sending the device control instruction to a central control host, so that the central control host controls the first controllable physical device in the exhibition hall to perform a corresponding operation.

6. The method of claim 5, further comprising:
in response to a device state of a second controllable physical device in the exhibition hall being changed, receiving a data update instruction sent by the central control host, the data update instruction comprising device information and a current device state of the second controllable physical device;
in response to the data update instruction, updating relevant data of the virtual exhibition hall model stored in a database; and
sending a model update instruction to the control terminal, the model update instruction comprising device information and a current device state of a second controllable virtual device that matches the second controllable physical device.

7. The method of claim 5, further comprising:
receiving collected data uploaded by a data collector disposed in the exhibition hall; and
processing the collected data to generate a processing result.

8. The method of claim 7, wherein the data collector comprises an image collector, and the collected data comprises image data; and
the step of processing the collected data comprises:
determining at least one of a real-time number of people in each area in the exhibition hall, an attribute of each person, and a movement trajectory of each person according to the image data.

9. The method of claim 7, after the step of processing the collected data, further comprising:
sending the processing result to the control terminal for the control terminal to display the processing result.

10. The method of claim 5, further comprising:
receiving a sensing result uploaded by a human sensor disposed in the exhibition hall;
in response to the sensing result being changed from absence of person to presence of person, sending a first operating state switching instruction to the central control host, so that the central control host controls a third controllable physical device corresponding to the human sensor to switch from a standby state to an operating state according to the first operating state switching instruction; and
in response to the sensing result being changed from presence of person to absence of person, sending a second operating state switching instruction to the central control host, so that the central control host controls the third controllable physical device corresponding to the human sensor to switch from the operating state to the standby state according to the second operating state switching instruction.

11. A method for controlling an exhibition hall, applied to a central control host, comprising:
in response to a first controllable virtual device in a virtual exhibition hall model displayed by a control terminal being operated, receiving through a back-end server a device control instruction sent by the control terminal, the device control instruction comprising device information of a first controllable physical device that matches the first controllable virtual device and operation information; and
in response to the device control instruction, controlling the first controllable physical device in the exhibition hall to perform a corresponding operation.

12. The method of claim 11, further comprising:
in response to monitoring that a device state of a second controllable physical device in the exhibition hall is changed, sending a data update instruction to the back-end server, so that the back-end server updates relevant data of the virtual exhibition hall model stored in a database and sends a model update instruction to the control terminal, the data update instruction comprising device information and a current device state of the second controllable physical device.

13. The method of claim 11, further comprising:
in response to a sensing result uploaded to the back-end server by a human sensor disposed in the exhibition hall being changed from absence of person to presence of person, receiving a first operating state switching instruction sent by the back-end server; and
controlling a third controllable physical device corresponding to the human sensor to switch from a standby state to an operating state according to the first operating state switching instruction.

14. The method of claim 11, further comprising:
in response to a sensing result uploaded to the back-end server by a human sensor disposed in the exhibition hall being changed from presence of person to absence of person, receiving a second operating state switching instruction sent by the back-end server; and
controlling a third controllable physical device corresponding to the human sensor to switch from an operating state to a standby state according to the second operating state switching instruction.

15. A control terminal, comprising a processor and a memory having a program stored therein, which, when executed by the processor, implements the steps of the method of claim 1.

16. A back-end server, comprising a processor and a memory having a program stored therein, which, when executed by the processor, implements the steps of the method of claim 5.

17. A central control host, comprising a processor and a memory having a program stored therein, which, when executed by the processor, implements the steps of claim 11.

18. An exhibition hall control system, comprising the control terminal of claim 15, a back-end server, and a central control host.
wherein the back-end server comprises a first processor and a first memory having a first program stored therein, which, when executed by the first processor, implements steps of: in response to a first controllable virtual device in a virtual exhibition hall model displayed by a control terminal being operated, receiving a device control instruction sent by the control terminal, the device control instruction comprising device information of a first controllable physical device that matches the first controllable virtual device, and operation information; and sending the device control instruction to the central control host, so that the central control host controls the first controllable physical device in the exhibition hall to perform a corresponding operation;
wherein the central control host comprises a second processor and a second memory having a second program stored therein, which, when executed by the second processor, implements steps of: in response to the first controllable virtual device in the virtual exhibition hall model displayed by the control terminal being operated, receiving through the back-end server the device control instruction sent by the control terminal; and in response to the device control instruction, controlling the first controllable physical device in the exhibition hall to perform the corresponding operation.

19. A computer-readable storage medium having instructions stored therein, which, when executed by a processor, implement the steps of the method of claim 1.

20. The method of claim 2, before the step of displaying the virtual exhibition hall model, further comprising:
obtaining relevant data of the virtual exhibition hall model from a database of the back-end server.
